(19) United States
(12) Patent Application Publication
(10) Pub. No.: US 2019/0005198 A1
(43) Pub. Date: Jan. 3, 2019

(54) MANAGING BUNDLED CLAIMS ADJUDICATION USING PREDICTIVE ANALYTICS

(71) Applicant: FAYOLA SUNRISE LLC, SEATTLE, WA (US)

(72) Inventors: Evan Wheeler Richards, Kirkland, WA (US); Katherine Holleran, Newton, MA (US)

(21) Appl. No.: 15/636,596

(22) Filed: Jun. 28, 2017

(51) Int. Cl. G06F 19/00

(52) U.S. Cl. CPC G06F 19/328

(57) ABSTRACT

Techniques are provided that facilitate managing claims adjudication associated with bundled payment arrangements using predictive analytics. In a computer-implemented is provided that comprises receiving, by a system operatively coupled to a processor, a current claim for reimbursement of a medical service rendered and determining whether the current claim is associated with a bundle of related claims. The method can further comprise, in response to determining that the current claim is associated with the bundle of related claims, determining, by the system, context information regarding one or more future claims included in the bundle of related claims that are likely to be received by the system for adjudication in the future, and determining, by the system, an adjudication response for adjudicating the current claim based on the context information.

### TECHNICAL FIELD

This application generally relates to claims adjudication and more particularly to computer-implemented techniques for managing bundled claims adjudication using predictive analytics.

### BACKGROUND

In the healthcare industry, claims adjudication refers to the determination of the insurer's payment or financial responsibility after the member's insurance benefits are applied to a medical claim. After the insurance company receives a claim, it performs a thorough adjudication review process to determine if the claim is valid, and if so, the amount of money the insurance company owes to the provider. This review process can include an automated software based review process, a manual review process, or a combination of both software and manual review. Based on the review process, the insurance company can decide to pay the claim in full, deny the claim, or to reduce the amount paid to the provider. The payment submitted to the medical office supplied by the insurance payer is called a remittance advice or explanation of payment.

Claims adjudication has become increasing difficult to perform accurately and efficiently for complex payment arrangements that are dependent on a combination of services and dates of service, such as bundled payment models, episode payment models, case rate payment models, and the like. For example, with these types of complex payment arrangements, claims received for services provided can be divided in the respect that multiple providers can provide different claims for a single patient event or encounter such as a procedure (e.g., a surgery) or a chronic illness. The amount of reimbursement for each claim received can depend on the amounts or reimbursement provided for the related claims received for the same patient event or encounter. In this regard, accurate claims adjudication is impaired by the timing and sequencing of claims submission.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that provide for managing claims adjudication associated with bundled payment arrangements using predictive analytics.

According to an embodiment of the present invention, a system can comprise a memory that stores computer executable components and a processor that executes the computer executable components stored in the memory. The computer executable components can comprise a related claims analysis component configured to evaluate a current claim received for adjudication and determine whether the current claim is associated with a bundle of related claims. The computer executable components can further comprise a context analysis component configured to determine, in response to a determination that the current claim is associated with the bundle of related claims, context information regarding one or more future claims included in the bundle of related claims that are likely to be received by the system for adjudication in the future, and an adjudication component configured to determine an adjudication response for adjudicating the current claim based on the context information. In various embodiments, the context component can be configured to determine the context information using a predictive analytical model developed using one or more machine learning techniques in association with analysis of historical claim data comprising adjudication information for previously adjudicated claims including same or similar attributes to the current claim.

In some embodiments, elements described in connection with the system can be embodied in different forms such as a computer-implemented method, a computer program product, or another form.

### DESCRIPTION OF THE DRAWINGS

FIG. 1 illustrates a block diagram of an example, non-limiting system that facilitates managing bundled claims adjudication using predictive analytics in accordance with one or more embodiments of the disclosed subject matter.

FIG. 2 illustrates is a block diagram of an example, non-limiting subsystem that facilitates generating adjudication rules, functions and predictive models based on machine learning analysis of historical claim data in accordance with one or more embodiments of the disclosed subject matter.

FIG. 3 illustrates is a block diagram of an example, non-limiting subsystem that facilitates performing bundled claims adjudication using predictive analytics in accordance with one or more embodiments of the disclosed subject matter.

FIG. 4 illustrates a flow diagram of an example, non-limiting process for performing claims adjudication in accordance with one or more embodiments of the disclosed subject matter.

FIG. 5 illustrates is a block diagram of another example, non-limiting subsystem that facilitates performing bundled claims adjudication using predictive analytics in accordance with one or more embodiments of the disclosed subject matter.

FIG. 6 provides a flow diagram of an example, non-limiting computer-implemented method for managing bundled claims adjudication using predictive analytics in accordance with one or more embodiments of the disclosed subject matter.

FIG. 7 provides a flow diagram of another example, non-limiting computer-implemented method for managing bundled claims adjudication using predictive analytics in accordance with one or more embodiments of the disclosed subject matter.

FIG. 8 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The subject disclosure provides systems, computer-implemented methods, apparatus and/or computer program products that provide for managing claims adjudication associated with bundled payment arrangements using predictive analytics. In particular, the disclosed systems, computer-implemented methods, apparatus and/or computer program products facilitate accurate and efficient automated (e.g., without manual review) claims adjudication for complex payment arrangements that are dependent on a combination of services and dates of service, such as bundled payment models, episode payment models, case rate payment models in the like. The terms bundled payment, episode payment, episode-based payment, episode-of-care payment, case rate, evidence-based case rate, global bundled payment, global payment, package pricing, packaged pricing, and the like are used herein interchangeably to refer to a payment model that defines the reimbursement of health care providers (e.g. hospitals and physicians) on the basis of expected costs for a defined group of clinically related services.

A bundled payment model is a type of payment arrangement that puts multiple providers together in the same financial risk pool. Typically, this term is used to describe payment where disparate providers who are paid under different payment methodologies (e.g. hospitals paid on diagnostic-related groups (DRGs) and physicians paid fee-for-service) are at risk together for the same budget or pool of funds. Some bundled payment programs make one payment to a single entity, traditionally a hospital, which then allocates the money among the participants. Other bundled payment models distribute reimbursements to a plurality of grouped participants that provided different services related to the same patient care event or encounter. For example, in Medicare's Bundled Payment for Care Initiative (BPCI), many of the more than four hundred and fifty participants are physician entities. Payments can be bundled or grouped based on various factors. For example, many bundled payment arrangements bundle payments for services around a single patient care event or encounter, such as a procedure, an admission, a chronic illness or the like. Today, references to bundled payment usually also entail episode rates. An episode of care consists of all clinically related services for one patient for a discrete diagnostic condition from the onset of symptoms until treatment is complete. Episode rates are thus budgets designed around a continuum of care for a specific patient for a specific condition. Episode rates or payments are also referred to in the healthcare insurance field as case rates.

To establish the payment amount for each service in a bundled payment model, boundaries in terms of time and the range of services to be included must be defined. For example, an episode of care around an acute myocardial infarction could include the admission and subsequent cardiac rehabilitation and other services until thirty or even one hundred and eighty days after discharge. Some episode rates can reach back and include the diagnostic services that established the condition. Episodes in chronic care, such as diabetes, congestive heart failure, or asthma typically extend for a full year to coincide with annual health insurance premiums. Episode-based payments and bundled payments will be increasingly important to primary care physicians and specialists such as cardiologists, endocrinologists, pulmonologists, and allergy and asthma specialists who treat a high volume of chronic care patients.

However, bundled payment or episode rates often come with numerous potential contracting pitfalls that make accurately and fairly determining and distributing reimbursement for services covered by the bundle payment plan a difficult process. For example, the contractual terms of a bundle payment model should define how a restricted pool of funds should be distributed to each potential service provider for each potential service included in the bundle. In this regard, the amount of reimbursement provided to one service provider for one service can influence the amount provided to another service provider for another related service. However, because of the lack of any uniformity to the sequencing of claim submission by service providers, the complete context associated with a claim with respect to what amounts were paid on any previously submitted related claims and what related claims will be received in the future is unknown. Accordingly, the ability to accurately and efficiently determine the appropriate reimbursement amount for a current claim is impaired by the timing and sequencing of claims submission. In addition, depending on the context of a service provided, it can be difficult to determine whether the service is included in a bundle payment arrangement, what service triggers a bundle, and when the bundle ends. In this regard, just because a particular service may be included in a bundled payment arraignment, whether the service is actually provided to a patient can depend on many variable factors.

The subject disclosure provides systems, computer-implemented methods, apparatus and/or computer program products that provide efficient, accurate and automated techniques for adjudicating claims included in a bundled payment arrangement using predictive analytics. In particular, based on analysis and evaluation of historical data regarding claims adjudicated in the past, the disclosed techniques can anticipate future claims to be paid, and/or identify claims that have been paid that are related to the claim in context for adjudication. In this regard, the disclosed techniques combine historical data and contract definitions to predict which claims from a bundle or episode are yet to be submitted and adjudicated when adjudicating a component claim in context. As a result, the adjudication results will accurately reflect the claim in context relative to the bundled payment arrangement and represent an appropriate payment rather than paying in full or inaccurately for that episode component.

In various embodiments, the disclosed techniques can initially involve the development and/or training, of one or more predictive algorithms and/or models that are configured to generate predicted output information that regarding the context surrounding a claim, including but not limited to: whether a claim is part of a bundle, what other related claims if any are likely to be received in the future, characteristics of the future claims (e.g., type of claim, what service the claims are for, places of service, which providers they are from, what amounts they will claim, etc.), when the future claims will be received (e.g., including time and sequencing), and the like. The disclosed techniques can further involve determining an appropriate adjudication response for the claim based in part on the context information information, including but not limited to: whether to reject the claim, approve the claim and if approved, the amount of reimbursement to provide, or whether to wait to re-evaluate the claim until a defined event occurs (e.g., one or more additional related claims are received, a defined period of time passes without reception of an additional claim, etc.). In some embodiments, the disclosed systems can further develop and/or train one or more predictive analytical models to facilitate determining the appropriate adjudication response (e.g., deny, approve, reduce, defer, etc.) to perform for a particular claim based on machine learning analysis of adjudicative responses performed for same or similar claims and/or claim bundles (e.g., including the anticipated claims). According to these embodiments, if approved, the one or more predictive analytical models can further be configured to determine a recommended payment amount (e.g., either in full or a reduced amount) for the claim based in part on the historical price points (including claimed amounts and reimbursed amounts) for same or similar claims and/or claim bundles in the past. Further, in some embodiments, if the context information identifies one or more additional related claims that are anticipated in the future; the subject predictive algorithms and/or models can also be configured to determine predicted reimbursement amounts to pay on the additional claims.

In one or more embodiments, the subject predictive algorithms and/or models can be developed and refined based on machine learning analysis of historical claim data for claims that were received and adjudicated in the past. For example, the historical claim data can include but is not limited to, information identifying previously submitted claims and characteristics or attributes associated with the past claims, such as but not limited to: claim type, type of service, a diagnosis related group (DRG) associated with the service, a severity of illness score associated with the type of service, place of service, service provider, claimed amount, adjudicative response taken, reimbursed amount, and whether the claim was considered part of a bundle. In some embodiments, the historical data can also include information regarding bundled claims, including but not limited to, whether a claim was considered included in a bundle, if so, other claims in the bundle, information regarding timing and reception of the other claims and information regarding attributes of the other claims. The machine learning analysis can also evaluate and factor in contract terms and definitions associated with the respective historical claims regarding the financial responsibility of the payer (e.g., the insurance company) for the respective claims.

The disclosed subject matter further provides systems, methods and computer-readable media configured to apply the one or more predictive algorithms and/or models to process new claims received for adjudication. In this regard, when a new claim is received, one or more appropriate predictive models and/or algorithms associated with the claimed service can be selected and applied to the claim to determine adjudication information including but not limited to: whether the claim is part of a bundle, what other related claims if any are likely to be received in the future, characteristics of the future claims (e.g., what services they are for, which providers they are from, what amounts they will likely claim, etc.), when the future claims will be received (e.g., including time and sequencing), and a recommended adjudication response for a claim (e.g., approve, deny, reduce, defer for revaluation until additional claims are received, etc.). The adjudication information determined for a newly received claim using the one or more predictive analytical models can be tailored or refined based on the contract terms associated with the claim.

In one or more embodiments, the adjudication information can be presented to a user to facilitate manual adjudication of the claim based on review of the adjudication information. In other embodiments, the disclosed systems can automatically initiate or carry out an adjudication response recommended for a received claim. For example, the disclosed systems can automatically reject a claim or facilitate automatic payment (e.g., auto-pay) of the claim based on the adjudication information. In some implementations, the disclosed systems can store information regarding all claims received for processing, including adjudication information determined for the respective claims as well as whether an adjudication response was automatically carried out (e.g., whether the claim was automatically rejected or paid and at what amount). With these embodiments, in addition to evaluating a newly received claim using one or more predictive adjudication models/algorithms in view of the contract terms for the claim, the disclosed techniques can further examine the relatively recent (e.g., within a defined time period for claims to be considered related) historical data to identify and consider any previously submitted and adjudicated claims that are related to the current claim. Further, as new historical data is received, it can be combined with the existing historical data and used to regularly update, train, and/or optimize the subject predictive adjudication models/algorithms.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

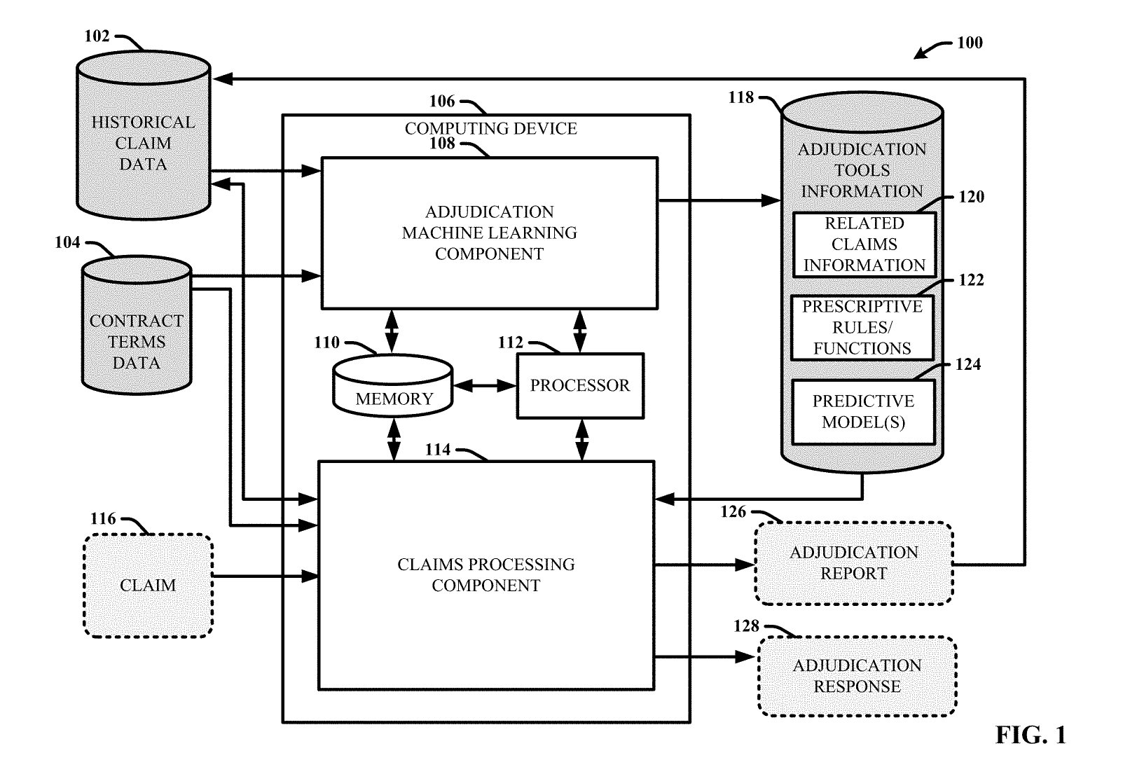

Turning now to the drawings, FIG. 1 illustrates a block diagram of an example, non-limiting system 100 that facilitates managing bundled claims adjudication using predictive analytics in accordance with one or more embodiments of the disclosed subject matter. System 100 and/or the components of the system 100 or other systems disclosed herein can be employed to use hardware and/or software to solve problems that are highly technical in nature, that are not abstract, and that cannot be performed as a set of mental acts by a human. Further, some of the processes performed can be performed by specialized computers for carrying out defined tasks related to developing and employing predictive models that determine adjudication information associated with adjudicating a claim included in a bundled claim payment arrangement based on historical claim data and defined contract terms using machine-learning techniques.

In this regard, one or more of the disclosed predictive models can predict contextual information associated with a claim received for payment of services rendered including but not limited to: whether the claim is included in a bundle, and if so, what other related claims are likely to be received, characteristics of those claims (e.g., claim type, type of service, a DRG associated with the service, a severity of illness score associated with the type of service, place of service, service provider, claimed amount, adjudicative response taken, reimbursed amount, etc.), when they will be received (e.g., including timing and order), and the like. Based on this context information, in view of the historical claims data and the contract terms associated with the claim, system 100 can further determine a recommended adjudication response for the claim, including by not limited to, rejecting the claim, approving the claim, or delaying processing of the claim until one or more additional related claims are received. In implementations in which the claim is approved, system 100 can further determine a reimbursement amount for the approved claim (e.g., either the claimed amount or a reduced amount). In some implementations in which the claim is part of a bundle and one or more anticipated claims are identified, the disclosed predictive models can further determine recommended reimbursement amounts for the one or more anticipated claims.

System 100 and/or components of system 100 or other systems described herein can be employed to solve new problems that arise through advancements in technology, computer networks, the Internet, and the like. System 100 or other systems detailed herein can provide technical improvements to automated claims adjudication systems with respect to accurately, fairly and efficiently determining appropriate reimbursement amounts for claims included in a bundled claim arraignment when the entire context regarding what other related claims that will be received and what they will claim, is unknown. Accordingly, by employing predictive analytical models to facilitate inferring the context surrounding a claim included in a bundle and further determining the appropriate amount of reimbursement to pay on the claim based on the context, the disclosed techniques significantly improve the processing time associated with adjudicating bundled claims. In addition, because the recommended adjudication response and associated reimbursement amount determined for a claim accurately and fairly reflects the bundled payment arrangement of the claim relative to the current context of the claim, the disclosed adjudication techniques can be employed to carry out automatic payment (auto-pay) of claims included in a bundle, even when anticipated additional related claims have not yet been received.

Embodiments of systems described herein can include one or more machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. For example, in the embodiment shown, system 100 includes a computing device 106 that includes an adjudication machine learning component 108 and a claims processing component 114. System 100 also includes various data sources and data structures comprising information that can be used by and/or generated by the adjudication machine learning component 108 and the claims processing component 114. For example, these data sources and data structures can include but are not limited to: historical claim data 102, contract terms data 104, and adjudication tools information 118. The computing device 106 can include or be operatively coupled to at least one memory 110 and at least one processor 112. The at least one memory 110 can further store executable instructions (e.g., the adjudication machine learning component 108 and the claims processing component 114), that when executed by the at least one processor 112, facilitate performance of operations defined by the executable instruction. In some embodiments, the memory 110 can also store the various data sources and/or structures of system 100 (e.g., the historical claim data 102, the contract terms data 104, and the adjudication tools information 118). In other embodiments, the various data sources and structure of system 100 can be stored in other memory (e.g., at a remote device or system), that is accessible to the computing device 106 (e.g., via one or more networks). Examples of said processor 112 and memory 110, as well as other suitable computer or computing-based elements, can be found with reference to FIG. 10, and can be used in connection with implementing one or more of the systems or components shown and described in connection with FIG. 1 or other figures disclosed herein. It should be appreciated that although various aspects of system 100 are exemplified in association with adjudicating medical claims, system 100 can be employed to facilitate various other types of claims that can be bundled or otherwise included in a bundled claim payment arrangement.

In one or more embodiments, the adjudication machine learning component 108 can be configured to employ one or more machine learning algorithms to generate and/or optimize the adjudication tools information 118 that can be used by the claims processing component 114 to automatically process (e.g., adjudicate) new claims. In particular, using one or more machine learning algorithms, the adjudication machine learning component 108 can be configured to analyze historical claim data 102 in view of contract terms data 104 to identify patterns and relationships between different types of claims, claim attributes and contract terms. In this regard, the historical claim data 102 can include historical information for past claims processed by a payer in accordance with the contract terms (e.g., included in the contract terms data 104) established between the payer and the claimant. For instance, in association with application of system 100 to facilitate adjudication of medical claims, the historical claim data 102 can include historical information for past medical claims processed by an insurance provider (or a system employed by the insurance provider) based on the contract terms (e.g., included in the contract terms data 104) established between the insurance provider and the medical service provider and/or patient associated with the claim.

For example, the historical claim data 102 can include information regarding all (or in some embodiments some) claims received by the insurance provider, attributes associated with the claims (e.g., claim type, type of service, a DRG associated with the service, a severity of illness score associated with the type of service, place of service, service provider, claimed amount, date of reception of the claim, etc.), adjudication responses performed for the respective claims (e.g., including approved or denied, approved amount, etc.), whether the claim was considered related to another claim and thus part of a bundled payment plan and if so, the related claims, etc. The contract terms data 104 can include information defining contract terms established between the insurance provider and respective patients and service providers insured by the insurance provider regarding financial responsibilities of the respective parties for services rendered. The contract terms data 104 can also include information regarding bundled payment arrangements established between the insurance provider, one or more service providers and the respective patients. For example, in some embodiments the information regarding the bundled payment arrangements can include information indicating and/or identifying what services are included in the bundled payment arrangement and how the insurance provider is to allocate funds for the respective services.

Based on the identified patterns and relationships identified between the various claim attributes, the contract terms, the adjudication responses performed for the respective claims and the like, the adjudication machine learning component 108 can determine information such as but not limited to: claims that are independent claims and claims that are part of bundle, historical prices points for the respective claims (including claimed amounts and paid amounts), how one or more attributes of bundled claims effect adjudication responses and reimbursement values associated with the related claims, future related claims that will likely be received based on reception of a particular claim, attributes of the future claims, timing and order of reception of the future claims, and the like. Based on all this information, the adjudication machine learning component 108 can develop and/or optimize rules and/or predictive models that can control how processing of new claims by the claims processing component 114.

For example, in some embodiments, based on the machine learning analysis of the historical claim data 102 and the contract terms data 104, the adjudication machine learning component 108 can develop related claims information 120 that identifies one or more bundles of related claims. In one implementation, each bundle of related claims can identify claims included in the bundle based on the respective services associated with each claim. In this regard, each bundle can include two or more related services and each bundle will vary by at least one service. In some implementations, the related claims information 120 can also identify claims or services that are not included in any bundles or that are otherwise to be treated as independent claims. In one or more embodiments, the claims processing component 114 can employ the related claims information 120 to facilitate determining if a received claim is part of a bundle of related claims.

The adjudication machine learning component 108 can further develop and/or optimize one or more prescriptive rules/functions 122 that can define fixed adjudication output information and/or responses for application by the claims processing component 114 based on fixed relationships identified between one or more discrete variables associated with a received claim. For example, the prescriptive rules/functions 122 can define a specific adjudication response (e.g., deny claim, approve claim, delay processing until occurrence of a defined event, etc.) based on one or more discrete attributes associated with a received claim and the context associated with the claim (e.g., the claim is not part of a bundle, the claim is the first claim received for a bundle, the claim is the last claim in the bundle, the claim is less than N amount, the claim is from provider M, the claim is for service Y, etc.).

The adjudication machine learning component 108 can also develop and/or optimize one or more predictive models 124 configured to predict information regarding the context of a received claim, such as but not limited to, whether the claim is included in a bundle, and if so, information regarding future related claims likely to be received (e.g., including attributes of the future claims). In some embodiments, the adjudication machine learning component 108 can further develop one or more models/algorithms that can also provide a recommended adjudication response for a claim based on one or more attributes of the claim, the context information, and one or more contract terms associated with the claim. For example, the one or more predictive models can be configured to determine adjudication response information regarding whether to approve the claim, deny the claim, or defer processing of the claim until reception of one or more related claims. In implementations in which a claim is approved, the one or more predictive models can further determine, based on historical pricing data for the claim and the related claims, a recommended value or reimbursement amount to pay on the claim (e.g., either in full or a reduced amount).

The claims processing component 114 can be configured to employ the adjudication tools information 118 to facilitate processing (e.g., adjudicating) new claims (e.g., claim 116). In this regard, the claims processing component 114 can be configured to receive a claim 116 submitted by a service provider (e.g., via a suitable application program interface API). When a new claim is received, the claims processing component 114 can be configured to process the claim using the adjudication tools information 118 to determine context information associated with the claim 116, including but not limited to: whether the claim is part of a bundle, what other related claims if any are likely to be received in the future, characteristics of the future claims (e.g., what services they are for, which providers they are from, what amounts they will likely claim, etc.), when the future claims will be received (e.g., including time and sequencing), and the like. Based on the claim attributes and the context information, the claims processing component can also be configured to employ the adjudication tools information 118 to determine a recommended adjudication response for the claim (e.g., approve claimed amount, approve a reduced amount, deny, defer for revaluation until additional claims are received, etc.). The claims processing component 114 can further tailor or refine the context information and/or the adjudication response information based on the contract terms associated with the claim included in the contract terms data 104. In some embodiments, the claim processing component 114 can also store information regarding all (or some) claims received for processing, including adjudication information determined for the respective claims as well as whether an adjudication response was automatically carried out (e.g., whether the claim was automatically rejected or paid and at what amount). With these embodiments, in addition to evaluating a claim using the adjudication tools information 118, the claims processing component 114 can also look into the historical data to determine and consider information regarding any previously submitted and adjudicated claims that are related to the current claim 116.

In one or more embodiments, the claims processing component 114 can be configured to provide the context information and/or the recommended adjudication response information to a user in the form of an adjudication report 126. For example, the adjudication report can include text, charts, images, etc., that can be displayed via a graphical user interface (GUI) and including information summarizing the evaluation of the received claim 116 by the claims processing component 114. According to these embodiments, the adjudication report can be employed by the user to facilitate manual adjudication of the claim based on review of the context information and the recommended adjudication response information. The claims processing component 114 can further store the adjudication report or otherwise add the information included in the adjudication report to the historical claim data 102. In some implementations, the adjudication machine learning component 108 can further regularly employ the updated historical claim data to optimize the adjudication tools information 118. In other embodiments, the claims processing component 114 can be configured to automatically initiate or carry out a recommended adjudication response 128 determined for the claim 116. For example, the claims processing component 114 can automatically reject a claim or facilitate automatic payment (e.g., auto-pay) of the claim based on the recommended adjudication response.

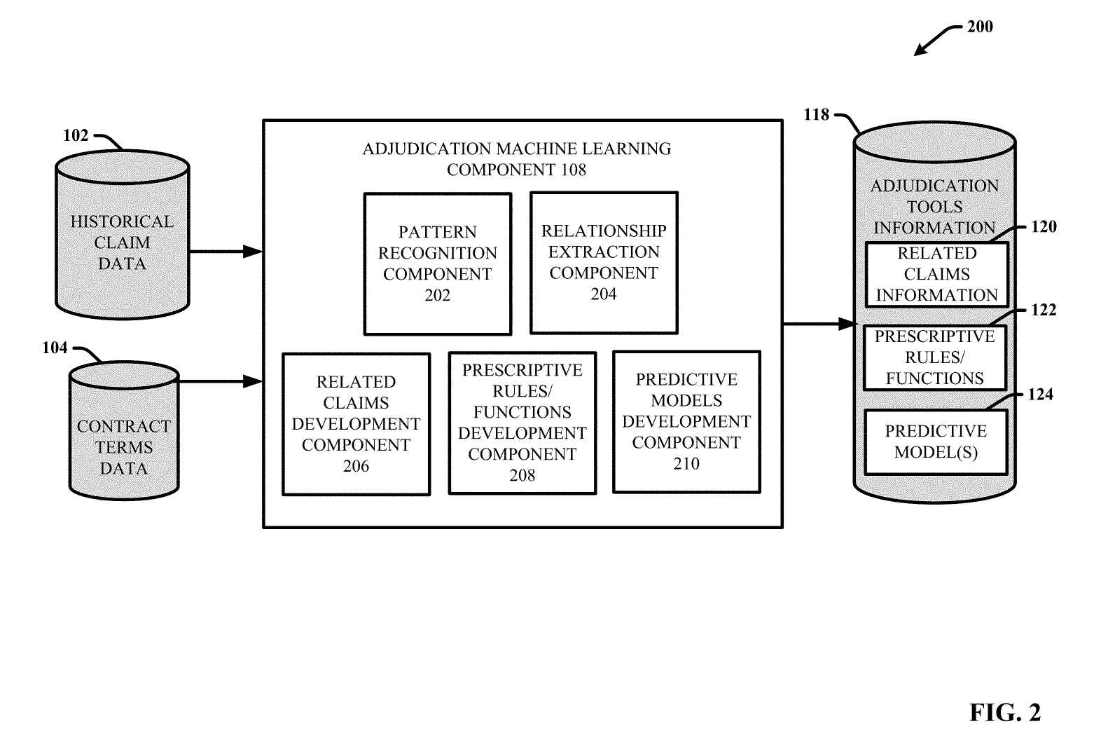

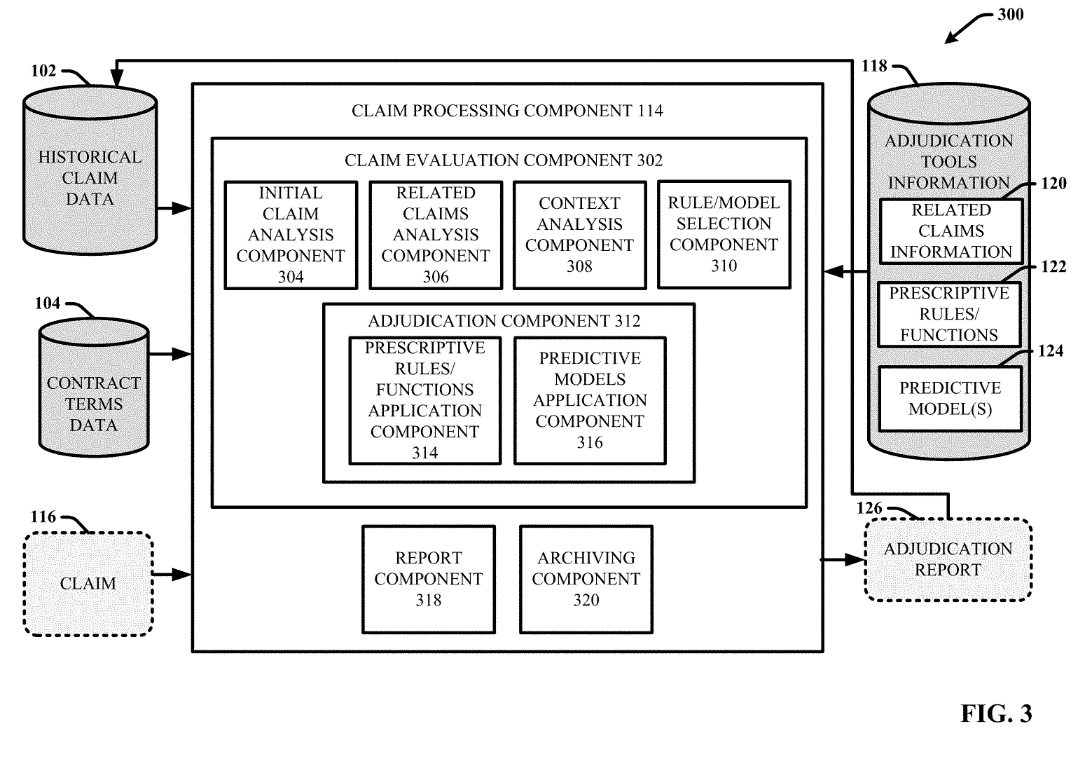

FIG. 2 provides additional detailed information regarding the adjudication machine learning component 108 and the mechanisms used to generate and/or optimize the adjudication tools information 118. FIGS. 3-6 provide additional detailed information regarding the claims processing component 114 and the associated processing functions employed to generate an adjudication report 126 and/or an adjudication response 128. Repetitive description of like elements employed in respective embodiments is omitted for sake of brevity.

With reference now to FIG. 2, illustrated is a block diagram of an example, non-limiting subsystem 200 that facilitates generating the adjudication tools information 118 in accordance with one or more embodiments of the disclosed subject matter. In various embodiments, subsystem 200 is a subsystem of system 100 (e.g., system 100 can include subsystem 200). For example, subsystem 200 can include the historical claim data 102, the contract terms data 104, the adjudication machine learning component 108, and the adjudication tools information 118. Repetitive description of like elements employed in other embodiments described herein is omitted for sake of brevity.

The subject techniques for managing claims adjudication of bundled claims are based on analysis of historical claim data 102 in view of contract terms data 104 to determine patterns and relationships between related claims. Based on these patterns and relationships, the adjudication machine learning component 108 can develop the related claims information 120, one or more prescriptive rules/functions 122 regarding how to process a received claim, and/or one or more predictive models 124. These one or more predictive models can include models configured to predict the context associated with a new claim (e.g., including whether the claim is part of a bundle and if so, information regarding future related claims likely to be received), and in some implementations, models configured determine a recommended adjudication response for the new claim, including a recommended reimbursement amount. The logic used by the adjudication machine learning component 108 to generate the related claims information 120, the prescriptive rules/functions 122 and the predictive models 124 can be based on machine learning and predictive analytics.

Machine learning is a type of artificial intelligence (AI) that provides computers with the ability to learn without being explicitly programmed Evolved from the study of pattern recognition and computational learning theory in AI, machine learning involves the study and construction of algorithms that can learn from and make predictions on data. Predictive analytics is the branch of the advanced analytics which is used to make predictions about unknown future events. Predictive analytics uses many techniques from data mining, statistics, modeling, machine learning, and AI to analyze current data to make predictions about future. The patterns found in the historical and transactional data (e.g., the historical claim data 102 and the contract terms data 104) can be used to identify risks and opportunities for the future. Predictive analytics models capture relationships among many factors, to assess risk with a particular set of conditions to assign a score or weight. While machine learning algorithms can be used for many purposes, in accordance with the discloses subject matter, the adjudication machine learning component 108 can be particularly configured to develop rules/functions and models that provide one or more predicted output variables based on defined input variables. In one or more embodiments, the adjudication machine learning component 108 can employ one or more machine learning algorithms based on regression analysis or classification analysis. In this regard, the machine learning algorithms can include but are not limited to: linear models (e.g., linear regression, logistic regression, etc.), tree-based models (e.g., decision tree, random forest, gradient boosting), and/or neural networks.

The adjudication machine learning component 108 can employ various classification (explicitly and/or implicitly trained) schemes and/or systems (e.g., support vector machines, neural networks, expert systems, Bayesian belief networks, fuzzy logic, data fusion engines, etc.) in connection with developing and optimizing the adjudication tools information 118. A classifier can map an input attribute vector, x=(x1, x2, x4, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In the embodiment shown, the adjudication machine learning component 108 can include pattern recognition component 202, relationship extraction component 204, related claims development component 206, prescriptive rules/functions development component 208, and the predictive models development component 210. In accordance with one or more embodiments, the pattern recognition component 202 can be configured to employ one or more machine learning algorithms to identify patterns in the historical claim data and/or the contract terms data 104. For example, the pattern recognition component 202 can determine patterns associated with one or more claim attributes and grouping of the respective claims into bundles. In another example, the pattern recognition component 202 can determine patterns associated with related claims and the order of reception related claims. Based on the various patterns identified, using one or more machine learning algorithms, the relationship extraction component 204 can be configured to determine mathematical relationships between the various claim attributes (e.g., claim type, type of service, service provider, DRG, claimed amount, timing of reception, order of reception, etc.), and/or contract terms. For example, the relationship extraction component 204 can determine relationships between one or more attributes of a particular claim and characteristics associated with one or more claims related to the particular claims, such a related claims that often are received with or after the claim, timing of reception of the related claims and attributes of the related claims. In another example, the relationship extraction component 204 can determine relationships between attributes associated with a claim and/or one or more claims that are related to the claim and appropriate adjudication responses for the claim and/or the one or more related claims (including denial of a claim, approval of a claim and an amount approved). In another example, the relationship extraction component 204 can determine relationships between various claim attributes and/or contact terms and related claims, including information regarding related claims that are likely to be received based on reception of a particular claim with certain attributes, based on one or more contract terms associated with the claim and/or based on one or more related claims (e.g., included in the same bundle) received prior to the particular claim. The relationship extraction component 204 can also determine information regarding likelihood of reception of related claims, timing of reception of related claims and attributes regarding the anticipated related claims (e.g., claimed amount, service provider, etc.).

In one or more embodiments, the related claims development component 206 can be configured to evaluate the various patterns and relationships identified and/or developed by the pattern recognition component 202 and/or the relationship extraction component 204 to develop the related claims information 120. In some implementations, the related claims information 120 can include user provided or user defined (e.g., based on the contract terms data 104) groupings of claim bundles or attributes of claims to be considered bundled claims. With these implementations, the related claims development component 206 can further develop more detailed information and/or metadata to associate with the different claim bundles regarding sub-bundles or clusters of claims within a bundle and attributes of the respective claims included in a bundle or sub-bundle (e.g., claim type, type of service, a DRG associated with the service, a severity of illness score associated with the type of service, place of service, service provider, etc.), and the like.

The prescriptive rules/functions development component 208 can be configured to evaluate the patterns and relationships identified and/or developed by the pattern recognition component 202 and/or the relationship extraction component 204 to develop the prescriptive rules/functions 122. In this regard, the prescriptive rules/functions 122 can include defined adjudication response recommendation information for applying to a claim based on one or more discrete input parameters associated with the claim, including one or more attributes of the claim, one or more contract terms associated with the claim, and one or more context parameters regarding whether the claim is associated with a bundle and/or if so, what other claims in the bundle have already been received. In this regard, based on consistently recognized patterns in the historical claim data 102 and the contract terms data 104 and consistently robust adjudication responses for certain inputs that do not vary based on various secondary, tertiary, etc dependent variables, the outputs for these inputs can be fixed. In this regard, based on a claim having certain defined attributes and/or have a certain defined context, the prescriptive rules/functions development component 208 can develop defined rules or functions that associate a defined adjudication response with the claim.

For example, in some implementations, the prescriptive rules/functions 122 can include information that states if a claim is not included in a bundle, the claim should be adjudicated based on the contract terms associated with the claim only. In other implementations the prescriptive rules/functions 122 can include information that states if a claim is part of a bundle yet is the first claim received for the bundle, subject to the contract terms for the claim, the claim should be approved and reimbursed in full. In another example, the prescriptive rules/functions 122 can include information that states if a claim is part of a bundle and it is the last remaining possible claim in the bundle, then subject to the contract terms for the claim, the claim should be approved and reimbursed with the remaining allocated funds for the bundle. In another example, the prescriptive rules/functions 122 can include information that states if a claim is part of a bundle that divides reimbursement for the claim between two or more service providers, the claim should be evaluated using a predictive model associated with the claim (e.g., included in the one or more predictive models 124). In yet another example, the prescriptive rules/functions 122 can include information that states if a claim is part of a bundle and other potential claims for the bundle have not yet been received, the claim should be evaluated using a predictive model associated with the claim (e.g., included in the one or more predictive models 124). It should be appreciated that these prescriptive rules/functions are merely exemplary and a variety of potential rules/functions can be included in the prescriptive rules/functions 122 that define a recommended adjudication response based on one or more distinctive parameters associated with a received claim.

The predictive models development component 210 can be configured to evaluate the patterns and relationships identified and/or developed by the pattern recognition component 202 and/or the relationship extraction component 204 to develop and/or optimize one or more predictive models 124 that can predict context information and/or determine recommended adjudicative responses for a claim included in a bundle. In particular, regarding the context information, the predictive models development component 210 can develop one or more predictive models based on the historical claim data 102 and the contract terms data 104 that can predict information regarding one or more potential claims that are likely to be received based on reception of a particular claim associated with a claim bundle. For example, in some embodiments, the related claims information 120 can provide information identifying claim bundles, including respective claims included in each (or in some implementations one or more) potential bundle. Thus in some implementations, based on attributes associated with a received claim, using the related claims information 120, it can be determined whether the received claim is included in a bundle and if so, what other related claims are included in the bundle that could potentially be received. However, in various implementations, a particular claim (or service) can be associated with various different bundles of related claims. Further although a particular claim is included in a bundle, depending on the context of the claim reception of all, some or any of the other claims may not be likely. As a result, predictions regarding one or more potential future related claims and information about the future related claims can vary depending on the specific attributes associated with a received claim and the context of the received claim.

Accordingly, in one or more embodiments, based on analysis of the historical claim data 102 and the contract terms data 104, the predictive models development component 210 can develop one or more predictive algorithms/models configured to predict contextual information associated with a received claim based on known attributes of the received claim, contract terms associated with the received claim, and in some implementations, known historical information regarding adjudication of any related claims received prior to the current claim. In particular, the predictive models development component 210 can develop and/or optimize one or more predictive models that map input parameters associated with the received claim to output parameters regarding contextual information associated with the received claim based on identified patterns and/or relationships in the historical claim data 102 and/or the contract terms data 104 for claims that are the same or similar to the received claim (e.g., with respect to attributes of the respective claims).

In this regard, the input parameters can include but are not limited to: one or more known or determinable attributes of the received claim (e.g., claim type, type of service, a DRG associated with the service, a severity of illness score associated with the type of service, place of service, service provider, claimed amount, etc.), one or more contract terms associated with the claim, and in some implementations, known information regarding one or more past claims related to the claim that have already been received (e.g., including attributes of the one or more past claims, information regarding timing of reception of the one or more past claims and/or information regarding adjudication responses determined for the one or more past claims). The output parameters regarding the context of the received claim can include but are not limited to: one or more claims related to the received claim that are likely to be received in the future and characteristics of the one or more related claims (e.g., service, service provider, DRG, claimed amount, etc.). In some implementations, the output parameters can also include information regarding predicted timing of reception of the one or more related claims, including order of reception of the one or more related claims. In some embodiments, the output information can also include scores or weights (e.g., percentages) associated with the one or more related claims that represent the likelihood, based on the input parameters regarding the received claim, the respective related claims will be received in the future.

In some embodiments, the predictive models development component 210 can further be configured to develop and/or train one or more predictive analytical models that facilitate determining the appropriate adjudication response (e.g., deny, approve, reduce, defer, etc.) to perform for a particular claim based on machine learning analysis of adjudicative responses performed for same or similar claims and/or claim bundles (e.g., including the anticipated claims). For example, with respect to claims identified as part of claim bundles, in some embodiments, in addition to development of one or more predictive models that can predict context information associated with a received claim regarding future claims to be received following the claim, the predictive models development component 210 can develop one or more predictive models that can determine a recommended adjudication response based on the received input parameters regarding a current claim and the context information surrounding the current claim. In this regard, the predictive models development component 210 can determine appropriate adjudication responses to perform for a claim included in a bundle in view of historical adjudicative responses performed for the same or similar claims to the current claim and the respective claims included in the bundle. For example, based on reception of a claim B following reception of claim A and a determination that related claims C, D and E are likely to follow, the predictive models development component 210 can develop a predictive model that determines, based on patterns in the historical data for claims similar to claims B and/or for the bundle of claims A, B, C, D and E, whether to deny, approve or defer adjudication of claim B until occurrence of a defined event (e.g., reception of claim C).

According to these embodiments, if a claim is approved, the one or more predictive analytical models can further be configured to determine a recommended payment amount (e.g., either in full or a reduced amount) for the claim based in part on the historical price points (including claimed amounts and reimbursed amounts) for same or similar claims and/or claim bundles in the past. For instance, in furtherance to the example above, the predictive model can further provide a recommended reimbursement valuation for claim B (e.g., either pay the claim in full or pay a reduced amount). For example, the predictive models development component 210 can develop, based on the historically characterized relationships between the current claim and the anticipated claims to be received following the current claim, and prospective claimed amounts of the anticipated claim, a recommended reimbursement amount to provide for the current claim. Further, in some embodiments, the one or more predictive models 124 can further include predictive models configured to generate pre-adjudicative response information for the one or more anticipated claims based on the historical claim data 102 and the contract terms data 104. In this regard, the predictive models can determine recommended adjudication responses for one or more claims related to a particular claim, including whether to deny or approve the one or more related claims and in some implementations, if approved, the recommended reimbursement amounts to provide for the one or more related claims.

FIG. 3 illustrates is a block diagram of an example, non-limiting subsystem 300 that facilitates performing bundled claims adjudication via the claims processing component 114 using predictive analytics in accordance with one or more embodiments of the disclosed subject matter. In various embodiments, subsystem 300 is a subsystem of system 100 (e.g., system 100 can include subsystem 300). For example, subsystem 300 can include historical claim data 102, contract terms data 104, claims processing component 114, adjudication tools information 118, a claim 116, and an adjudication report 126. Repetitive description of like elements employed in respective embodiments is omitted for sake of brevity.

The claims processing component 114 can be configured to perform and/or manage adjudication of new claims (e.g., claim 116), based on the contract terms associated with the claim (e.g., included in contract terms data 104) and further using the adjudication tools information 118 developed and/or refined by the adjudication machine learning component 108. In the embodiment shown, the claims processing component 114 can include claim evaluation component 302, report component 318 and archiving component 320. The claims evaluation component 302 can be configured to evaluate a new claim 116 to determine adjudication information for the claim, including context information associated with the claim, including but not limited to, whether the claim 116 is part of a bundle and if so information regarding one or more predicted claims in the bundle that are likely to be received. For example the information regarding the one or more predicted claims can include information identifying the one or more predicted claims, attributes of the predicted claims (e.g., claim type, type of service, a DRG associated with the service, a severity of illness score associated with the type of service, place of service, service provider, predicted claimed amount, etc.), and information regarding timing of reception of the one or more predicted claims (e.g., including order of reception. In some implementations, the adjudication information can also include scores and/or values associated with the one or more predicted claims that indicate the likelihood of reception. In some embodiments, in addition to context information, the claim evaluation component 302 can determine one or more recommended adjudication responses for the claim 116, including whether to deny the claim, approve the claim (and a what amount), or defer adjudication of the claim until later (e.g., until occurrence of a defined event). Further, in some embodiments in which the claim is associated with one or more related claim, the adjudication information can include one or more pre-adjudication responses recommended for the one or more related claims yet to be received.

In some embodiments, the adjudication information determined by the claim evaluation component 302 can be summarized in a report. According to these embodiments, the report component 318 can be configured to generate an adjudication report 126 including the adjudication information for presentation to a user (e.g., via a GUI) to facilitate manual adjudication of the claim based on review of the adjudication information. In some implementations, the archiving component 320 can store information regarding all (or in some embodiments one or more) claims evaluated by the claim evaluation component 302, including adjudication information determined for the respective claims (as well as information whether an adjudication response was automatically carried out such as whether the claim was automatically rejected or paid and at what amount) in the historical claim data 102. For example, in the embodiment shown, the adjudication report 126 is added to the historical claim data 102. With these embodiments, in association with evaluating a newly received claim 116 using the adjudication tools information and the contract terms data 104, the disclosed claim evaluation component 302 further examine the relatively recent (e.g., within a defined time period for claims to be considered related) historical data to identify and consider any previously submitted and adjudicated claims that are related to the current claim 116.

Further, as new historical data is received, it can be combined with the existing historical data and used to regularly update, train, and/or optimize the one or more predictive adjudication models/algorithms included with the predictive models 124. For example, in one or more embodiments, the adjudication information determined by the claim evaluation component 302 for a current claim 116 can include information regarding one or more claims included in a bundle associated with the current claim 116 that is determined to likely be received in the future. As time passes and new claims are received, evaluated and archived, the historical claim data 102 will include information that can be used to evaluate whether the prediction associated with claim 116 was accurate. In this regard, if the one or more anticipated claims are actually received, the model accuracy of the model can be confirmed. However, if any of the one or more anticipated claims are not received, the model can be updated to account for the inaccurate predication.

Regarding the claim evaluation component 302, in the embodiment shown, the claim evaluation component 302 can include initial claim analysis component 304, related claims analysis component 306, context analysis component 308, rule/model selection component 310 and adjudication component 312. The initial claim analysis component 304 can be configured to perform one or more initial processing functions associated with a received claim 116 prior to application of the adjudication tools information 118 to the claim. This initial processing can include evaluating the claim in view of the contract terms associated with the claim (e.g., based on the claim provider and/or the patient associated with the claim) to determine whether the claim is a valid claim. For example, this initial processing can involve standard claims adjudication practices involving determining whether the member is eligible, if a required authorization for the claim was performed, and the like. If the claim 116 passes the initial processing examination and is considered a valid claim, the claim can be passed to the related claims analysis component 306 for further review.

In one or more embodiments, the related claims analysis component 306 can be configured to determine or predict whether the claim 116 is associated with a claims bundle including one or more related claims. In particular, the related claims analysis component 306 can examine attributes of the received claim (e.g., claim type, type of service, a DRG associated with the service, a severity of illness score associated with the type of service, place of service, service provider, claimed amount) in view of the contract terms for the claim and/or the related claims information 120 to determine or infer if the claim is associated with at least one potential bundle of claims. In some implementations, the related claims evaluation component 306 can also examine the historical claim data 102 to determine whether the claim is part of a bundle based on information included in the historical claims data identifying one or more claims related to the current claim 116 that have already been received and processed by the claims processing component.

In various embodiments, if the related claims analysis component 306 determines the claim 116 is associated with one or more claims bundle, the claim 116 can further be evaluated by the context analysis component 308 to determine context information regarding one or more claims included in the one or more claim bundles that are likely to be received in the future. In this scenario, the context analysis component 308 can be configured to determine the context information using one or more predictive analytical models included in the predictive models 124. In particular, the context analysis component 308 can access and employ a predictive model included in the predictive models 124 that relates attributes associated with the current claim 116 and in some embodiments, contract terms associated with the current claim, to one or more defined related claims. In some implementations, the predictive model can also determine information regarding timing and/or order of reception of the one or more related claims. Further in some implementations, the predictive model can also determine information regarding likelihood of reception of the respective related claims and attributes of the respective related claims.

In various embodiments, the context information determined by the context analysis component 308 using one or more predictive models can be included in the adjudication report. In other embodiments, the context information can be employed to facilitate determining one or more adjudication responses associated with the current claim 116. For example, in one or more implementations, the rule/model selection component 310 can be configured to evaluate the context information determine for the claim 116 (regarding if the claim 116 is part of a bundle and if so, information regarding one or more related claims anticipated in the future) in view of the attributes associated with the claim, the contract terms associated with the claim, and potentially historical data regarding any related claims already received, to determine how the adjudication component 312 should proceed with adjudicating the claim 116. In this regard, the rule/model selection component 310 can initially review the prescriptive rules/functions 122 to determine whether the input information associated with the claim 116 (e.g., the claim attributes, the context information, the contract terms and/or the any previously received related claims) includes one or more defined parameters that are associated with a predefined adjudication response (e.g., deny, approve full amount, approve a reduced amount, defer, etc.) included in the prescriptive rules/functions 122. For example, if the input parameters indicate the claim 116 is not part of a bundle, the prescriptive rules/functions 122 can include information that instructs the adjudication component 312 to perform a defined adjudication response (e.g., pay the claim solely based on the contract terms). In another example, if the input parameters indicate the claim 116 is the first claim received for a bundle, the prescriptive rules/functions 122 can include information that instructs the adjudication component 312 to perform another defined adjudication response (e.g., wait to adjudicate the claim until another related claim is received or until passage of defined amount of time).

In one or more embodiments, if the rule/model selection component 310 identifies an applicable prescriptive rule/function for the claim 116 included in the prescriptive rules/functions 122, the rule/model selection component 310 can direct the adjudication component 312 to adjudicate the claim 116 based on the applicable rule/function. For example, in the embodiment shown, the adjudication component 312 can include a prescriptive rules/functions application component 314 that is specifically configured to adjudicate a claim using an applicable rule/function selected by the rule/model selection component 310. However, in other embodiments, if the rule/model selection component 310 does not identify an applicable prescriptive rule/function for the claim 116 included in the prescriptive rules/functions 122, the rule/model selection component 310 can direct the adjudication component 312 to adjudicate the claim 116 using one or more predictive models 124 included in the prescriptive models that is configured to determine an adjudication response for the claim 116 based on machine learning of historical claim data 102 including adjudication responses determined for same or similar claims. In this regard, the adjudication component 312 can include predictive models application component 316 to apply a predictive adjudication response model to the claim to determine a recommended adjudication response for the claim. For example, the predictive adjudication response model can relate information regarding the attributes of the claim 116 (e.g., type of claim, type of service, service provider, claimed amount) and the one or more anticipated related claims likely to be received in the future (e.g., type of claim, type of service, service provider, predicted claimed amount determine based on the historical data, etc.) to a recommended adjudication response (e.g., deny, approve, reduce, defer). In some embodiments, the predictive adjudicative response model can further determine a recommended reimbursement amount to provide for the claim 116 based on the attributes of the claim 116, the context information, and/or contract terms associated with the claim. Further in some implementations, the predictive adjudicative response model can also determine recommended pre-adjudication response information for the one or more related claims.

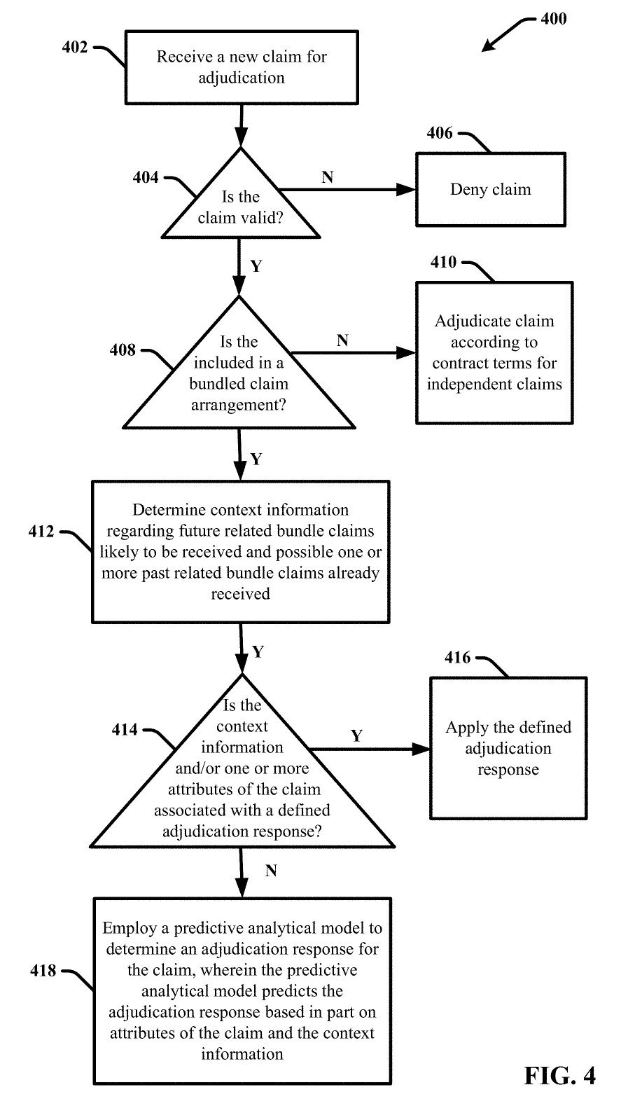

FIG. 4 illustrates a flow diagram of an example, non-limiting process 400 for performing claims adjudication in accordance with one or more embodiments of the disclosed subject matter. In one or more embodiments, process 400 presents an example evaluation processed that can be performed by the claim evaluation component 302 in association with evaluating a received claim (e.g., claim 116). Repetitive description of like elements employed in respective embodiments is omitted for sake of brevity.

At 402, a new claim is received for adjudication (e.g., by the claim processing component 114). At 404, the claim evaluation component 302 can perform an initial evaluation of the claim to determine whether the claim is valid in view of the contract terms associated with the claim (e.g., including determining if the member is eligible, if the claim was appropriately authorized, etc.). If not, then the claim is denied at 406. However, if the claim is valid, then at 408, the claim evaluation component 302 can determine whether the claim is included in a bundled claim arrangement (e.g., by the related claims analysis component 306). If not, then at 410 the claim can be processed according to contract terms associated with the claim for independent claims. However, if the claim is included in a bundled claim arrangement, then at 412, the claim evaluation component 302 can determine context information for the claim regarding future related bundle claims likely to be received and possibly one or more past related bundle claims already received (e.g., via the context analysis component 308). In various embodiments, this context information can be determined using one or more predictive analytical models that correlates attributes associated with the current claim to one or more related claims based on machine learning analysis of historical data for claims including same or similar attributes of the current claim. At 414, the claim evaluation component 302 can determine whether the context information and/or one or more attributes of the claim are associated with a defined adjudication response (e.g., via the rule/model selection component 310 based on review of the prescriptive rules/functions 122). If so, then at 416, the claim evaluation component 302 can apply the defined adjudication response (e.g., via the prescriptive rules/functions application component 314). If not, then at 418, the claim evaluation component 302 can employ a predictive analytical model to determine an adjudication response for the claim (e.g., using the predictive models application component 316), wherein the predictive analytical model predicts the adjudication response based in part on attributes of the claim and the context information.

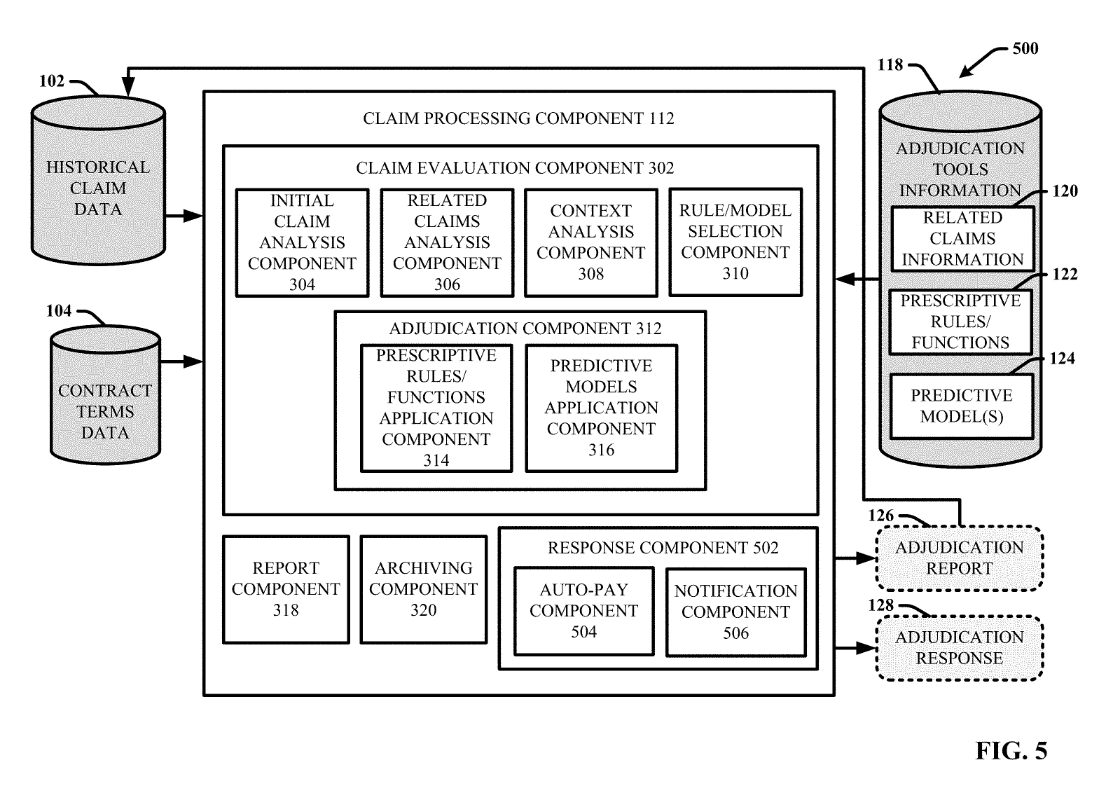

FIG. 5 illustrates is a block diagram of another example, non-limiting subsystem 500 that facilitates performing bundled claims adjudication using predictive analytics in accordance with one or more embodiments of the disclosed subject matter. Subsystem 500 can include same or similar features as subsystem 300 with the addition of response component 502 and an adjudication response 128. Repetitive description of like elements employed in respective embodiments is omitted for sake of brevity.

In various embodiments, in addition to and/or in the alternative to providing adjudication information determined by the claim evaluation component 302 in the form of an adjudication report 126, the claims processing component 114 can include response component 502 to automatically effectuate one or more responses based on the adjudication information. In particular, in some embodiments, the response component 502 can include an auto-pay component 504 that can be configured to automatically provide reimbursement for an approved claim at the approved amount (e.g., either a full amount or a reduced amount). In this regard, the auto-pay component 504 can be communicatively coupled with an electronic billing system employed by the insurance company or entity responsible for paying the reimbursement to the service provider (or providers) associated with a claim and the auto-pay component 504 can authorize and direct the electronic billing system to perform the payment. Further in some implementations in which the adjudication component 312 determines one or more pre-adjudication reimbursement amounts for one or more anticipated claims, the auto-pay component 504 can also be configured to automatically submit payment for the one or more anticipated claims (to the appropriate service providers), a the pre-adjudicated amount.

In association with performing automatic payments, in some embodiments, the auto-pay component 504 can be configured to automatically initiate payment for any approved claim regardless of the approved amount. In other embodiments, the prescriptive rules/functions can further include one or more auto-pay rules and/or functions that facilitate controlling automatic payment of approved claims. For example, in some implementations, the auto-payment rules can restrict automatic payment of claims based on the amount of the claims being less than a threshold amount. In other implementations, the auto-payment rules can restrict automatic payment of claims based on a determined degree of risk associated with performance of the automatic payment for each particular claim. In this regard, the auto-pay rules and/or functions can balance financial risk associated with paying too much and/or paying for pre-adjudicated claims that may not be received in view of improving the overall efficiency of medical claims billing and potentially receiving incentives (e.g., reduced costs) from the service providers for providing automatic payments and pre-adjudicated payments.

In addition to performing automatic payments, the response component 502 can also include a notification component 506 to provide notifications to one or more defined entities regarding the adjudication information determined for a claim and/or an auto-payment performed for a claim. For example, in some implementations in which one or more service providers are provided with an automatic payment for a pre-adjudicated anticipated claim, the notification component 506 can be configured to send notifications to the one or more service providers regarding the payment. In one embodiment, if the adjudication information provides information regarding one or more anticipated claims related to a current claim being adjudicated, the notification component can be configured to send notifications to the service providers (or other suitable entities) responsible for submitting the one or more anticipated claims asking them, reminding them, or prompting them to submit the one or more anticipated claims. In another example, in an implementation in which a current claim being adjudicated is associated with a bundled claim arrangement involving a plurality of different service providers, the notification component 506 can be configured to send the other service provides notifications regarding the current claim and the adjudication response determined for the current claim.

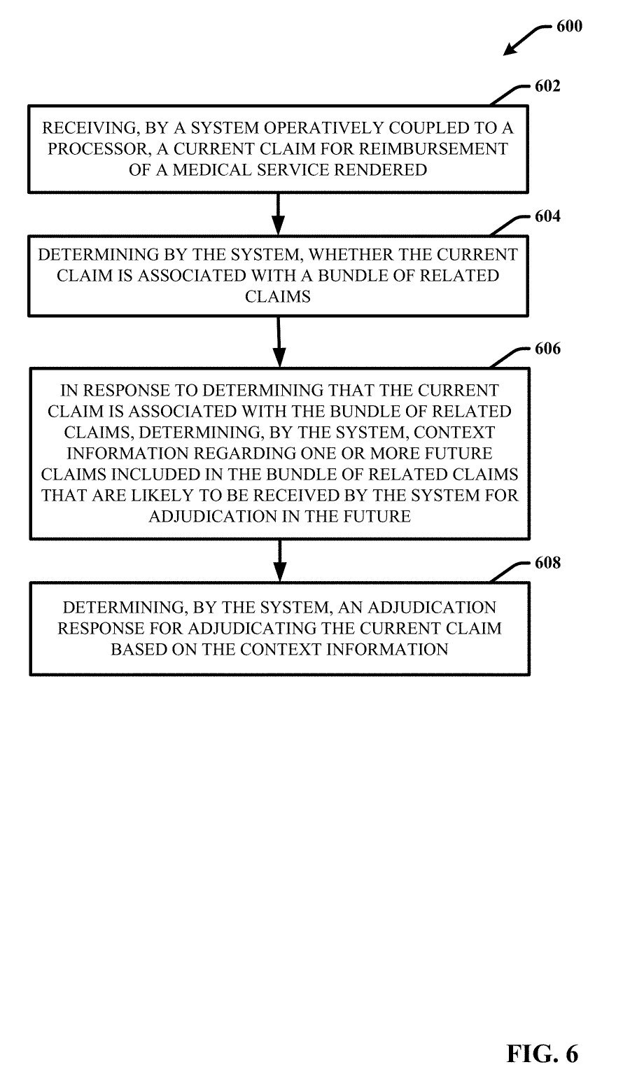

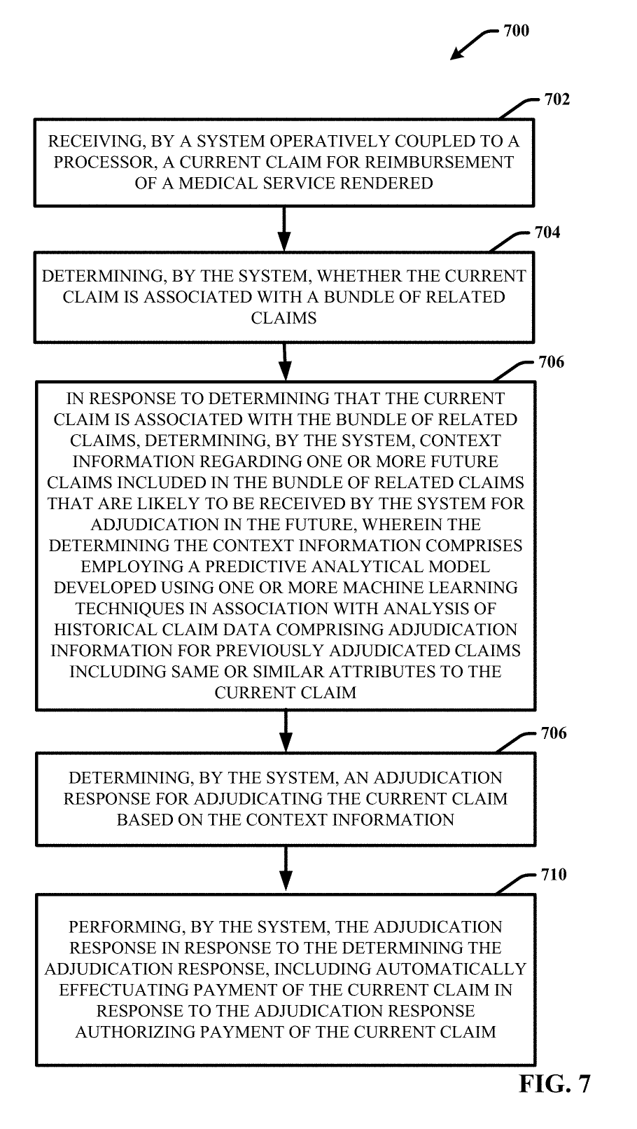

FIGS. 6-7 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

FIG. 6 provides a flow diagram of an example, non-limiting computer-implemented method 600 for managing bundled claims adjudication using predictive analytics in accordance with one or more embodiments of the disclosed subject matter. Repetitive description of like elements employed in respective embodiments is omitted for sake of brevity.

At 602, a system operatively coupled to a processor (e.g., system 100), receives a current claim for reimbursement of a medical service rendered. At 604, the system determine whether the current claim is associated with a bundle of related claims (e.g., via related claims analysis component 306). At 606, in response to determining that the current claim is associated with the bundle of related claims, the system determines context information regarding one or more future claims included in the bundle of related claims that are likely to be received by the system for adjudication in the future (e.g., via context analysis component 308). At 608, the system further determines an adjudication response for adjudicating the current claim based on the context information (e.g., via adjudication component 312).

FIG. 7 provides a flow diagram of another example, non-limiting computer-implemented method 700 for managing bundled claims adjudication using predictive analytics in accordance with one or more embodiments of the disclosed subject matter. Repetitive description of like elements employed in respective embodiments is omitted for sake of brevity.

At 702, a system operatively coupled to a processor (e.g., system 100), receives a current claim for reimbursement of a medical service rendered. At 704, the system determines whether the current claim is associated with a bundle of related claims (e.g., via related claims analysis component 306). At 706, in response to determining that the current claim is associated with the bundle of related claims, the system determines context information regarding one or more future claims included in the bundle of related claims that are likely to be received by the system for adjudication in the future, wherein the determining the context information comprises employing a predictive analytical model developed using one or more machine learning techniques in association with analysis of historical claim data comprising adjudication information for previously adjudicated claims including same or similar attributes to the current claim (e.g., via context analysis component 308). At 708, the system further determines an adjudication response for adjudicating the current claim based on the context information (e.g., via adjudication component 312). At 710, the system performs the adjudication response in response to the determining the adjudication response, including automatically effectuating payment of the current claim in response to the adjudication response authorizing payment of the current claim (e.g., via response component 602).

One or more embodiments can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

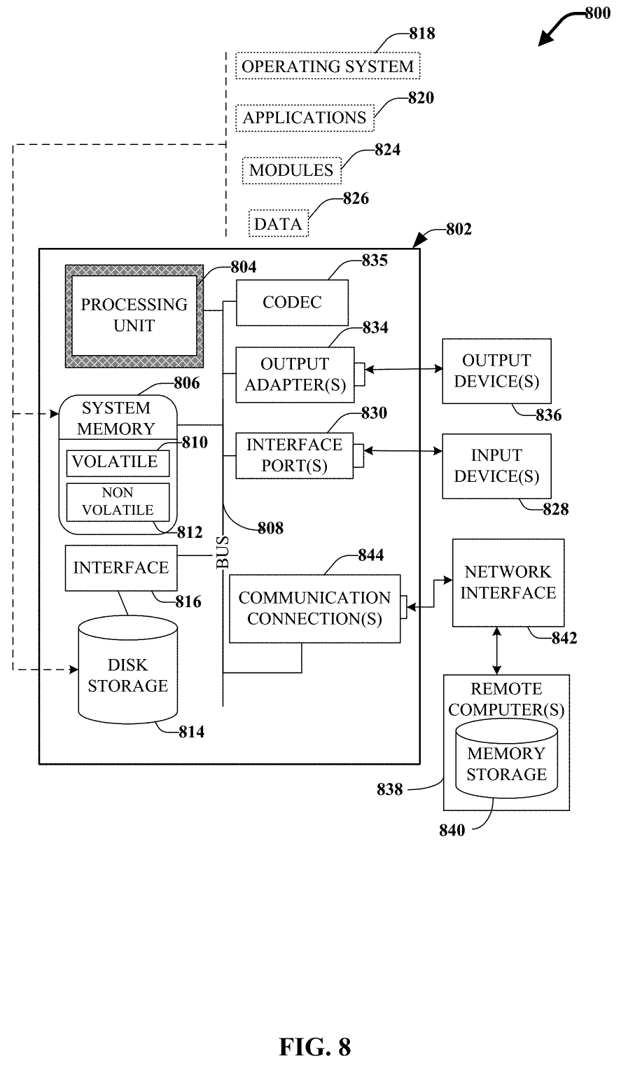

In connection with FIG. 8, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 8, an example environment 800 for implementing various aspects of the claimed subject matter includes a computer 802. The computer 802 includes a processing unit 804, a system memory 806, a codec 835, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 806 includes volatile memory 810 and non-volatile memory 812, which can employ one or more of the disclosed memory architectures, in various embodiments. The basic input/output system (BIOS), containing the basic routines to transfer information between elements within the computer 802, such as during start-up, is stored in non-volatile memory 812. In addition, according to present innovations, codec 835 can include at least one of an encoder or decoder, wherein the at least one of an encoder or decoder can consist of hardware, software, or a combination of hardware and software. Although, codec 835 is depicted as a separate component, codec 835 can be contained within non-volatile memory 812. By way of illustration, and not limitation, non-volatile memory 812 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 812 can employ one or more of the disclosed memory devices, in at least some embodiments. Moreover, non-volatile memory 812 can be computer memory (e.g., physically integrated with computer 802 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 810 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 802 can also include removable/non-removable, volatile/non-volatile computer storage medium. FIG. 8 illustrates, for example, disk storage 814. Disk storage 814 includes, but is not limited to, devices like a magnetic disk drive, solid state disk (SSD), flash memory card, or memory stick. In addition, disk storage 814 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 814 to the system bus 808, a removable or non-removable interface is typically used, such as interface 816. It is appreciated that disk storage 814 can store information related to a user. Such information might be stored at or provided to a server or to an application running on a user device. In one embodiment, the user can be notified (e.g., by way of output device(s) 836) of the types of information that are stored to disk storage 814 or transmitted to the server or application. The user can be provided the opportunity to opt-in or opt-out of having such information collected or shared with the server or application (e.g., by way of input from input device(s) 828).

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer system 802. Applications 820 take advantage of the management of resources by operating system 818 through program modules 824, and program data 826, such as the boot/shutdown transaction table and the like, stored either in system memory 806 or on disk storage 814. It is to be appreciated that the claimed subject matter can be implemented with various operating systems or combinations of operating systems.

A user enters commands or information into the computer 802 through input device(s) 828. Input devices 828 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 804 through the system bus 808 via interface port(s) 830. Interface port(s) 830 include, for example, a serial port, a parallel port, a game port, and a universal serial bus (USB). Output device(s) 836 use some of the same type of ports as input device(s) 828. Thus, for example, a USB port can be used to provide input to computer 802 and to output information from computer 802 to an output device 836. Output adapter 834 is provided to illustrate that there are some output devices 836 like monitors, speakers, and printers, among other output devices 836, which require special adapters. The output adapters 834 include, by way of illustration and not limitation, video and sound cards that provide a means of connection between the output device 836 and the system bus 808. It should be noted that other devices or systems of devices provide both input and output capabilities such as remote computer(s) 838.

Computer 802 can operate in a networked environment using logical connections to one or more remote computers, such as remote computer(s) 838. The remote computer(s) 838 can be a personal computer, a server, a router, a network PC, a workstation, a microprocessor based appliance, a peer device, a smart phone, a tablet, or other network node, and typically includes many of the elements described relative to computer 802. For purposes of brevity, only a memory storage device 840 is illustrated with remote computer(s) 838. Remote computer(s) 838 is logically connected to computer 802 through a network interface 842 and then connected via communication connection(s) 844. Network interface 842 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 844 refers to the hardware/software employed to connect the network interface 842 to the bus 808. While communication connection 844 is shown for illustrative clarity inside computer 802, it can also be external to computer 802. The hardware/software necessary for connection to the network interface 842 includes, for exemplary purposes only, internal and external technologies such as, modems including regular telephone grade modems, cable modems and DSL modems, ISDN adapters, and wired and wireless Ethernet cards, hubs, and routers.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes computer executable components stored in the memory, wherein the computer executable components comprise:
a related claims analysis component configured to evaluate a current claim received for adjudication and determine whether the current claim is associated with a bundle of related claims;
a context analysis component configured to determine, in response to a determination that the current claim is associated with the bundle of related claims, context information regarding one or more future claims included in the bundle of related claims that are likely to be received by the system for adjudication in the future; and
an adjudication component configured to determine an adjudication response for adjudicating the current claim based on the context information.

2. The system of claim 1, wherein the context component is configured to determine the context information using a predictive analytical model developed using one or more machine learning techniques in association with analysis of historical claim data comprising adjudication information for previously adjudicated claims including same or similar attributes to the current claim.

3. The system of claim 2, further comprising:
an archiving component configured to store information regarding the current claim and the adjudication response determined for the current claim with the historical claim data, thereby resulting in updated historical claim data, and wherein the predictive analytical model is further optimized in real-time based on the updated historical claim data.

4. The system of claim 1, wherein the context information comprises attribute information identifying attributes of the one or more future claims.

5. The system of claim 1, wherein the context information comprises timing information regarding timing of reception of the one or more future claims.

6. The system of claim 1, wherein the adjudication response is selected from the group consisting of: denying the current claim, approving the current claim at the claimed value, approving the current claim at a reduced value, and deferring adjudication of the current claim until occurrence of a defined event.

7. The system of claim 1, wherein the adjudication component is configured to determine the adjudication response using a predictive analytical model developed using one or more machine learning techniques in association with analysis of historical claim data comprising adjudication information for previously adjudicated claims including same or similar attributes to the current claim.

8. The system of claim 1, further comprising:
a response component configured to perform the adjudication response in response to determination of the adjudication response, including automatically effectuating payment of the current claim in response to the adjudication response authorizing payment of the current claim.

9. The system of claim 1, wherein the adjudication component is further configured to determine one or more pre-adjudication responses for adjudicating the one or more future claims based on the adjudication response determined for the current claim and the context information.

10. The system of claim 9, further comprising:
a response component configured to perform the one or more pre-adjudication responses in response to determination of the one or more pre-adjudication responses, including automatically effectuating payment of the one or more future current claim in response to the one or more pre-adjudication responses authorizing payment of the one or more future claims.

11. The system of claim 9, further comprising:
a notification component configured to notify one or more service providers associated with the one or more future claims regarding anticipated reception of the one or more future claims and the one or more pre-adjudication responses determined for the one or more future claims.

12. A computer-implemented method comprising:
receiving, by a system operatively coupled to a processor, a current claim for reimbursement of a medical service rendered;
determining by the system, whether the current claim is associated with a bundle of related claims;
in response to determining that the current claim is associated with the bundle of related claims, determining, by the system, context information regarding one or more future claims included in the bundle of related claims that are likely to be received by the system for adjudication in the future; and
determining, by the system, an adjudication response for adjudicating the current claim based on the context information.

13. The computer-implemented method of claim 12, wherein the determining the context information comprises employing a predictive analytical model developed using one or more machine learning techniques in association with analysis of historical claim data comprising adjudication information for previously adjudicated claims including same or similar attributes to the current claim.

14. The computer-implemented method of claim 13, further comprising:
storing, by the system, information regarding the current claim and the adjudication response determined the current claim with the historical claim data, thereby resulting in updated historical claim data; and
updating, by the system, the predictive analytical model in real-time based on the updated historical claim data.

15. The computer-implemented method of claim 12, wherein the context information comprises attribute information identifying attributes of the one or more future claims, and timing information regarding timing of reception of the one or more future claims.

16. The computer-implemented method of claim 12, wherein the adjudication response is selected from the group consisting of: denying the current claim, approving the current claim at the claimed value, approving the current claim at a reduced value, and deferring adjudication of the current claim until occurrence of a defined event.

17. The computer-implemented method of claim 12, wherein the determining the adjudication response comprises using a predictive analytical model developed using one or more machine learning techniques in association with analysis of historical claim data comprising adjudication information for previously adjudicated claims including same or similar attributes to the current claim.

18. The computer-implemented method of claim 12, further comprising:
performing, by the system, the adjudication response in response to the determining the adjudication response, including automatically effectuating payment of the current claim in response to the adjudication response authorizing payment of the current claim.

19. A machine-readable storage medium, comprising executable instructions that, when executed by a processor, facilitate performance of operations, comprising:
receiving a current claim for reimbursement of a medical service rendered;
determining whether the current claim is associated with a bundle of related claims associated with a bundled payment arrangement;
in response to determining that the current claim is associated with the bundle of related claims, determining context information regarding one or more future claims included in the bundle of related claims that are likely to be received for adjudication in the future; and
determining an adjudication response for adjudicating the current claim based on the context information.

20. The computer-implemented method of claim 12, wherein the determining the context information comprises employing a predictive analytical model developed using one or more machine learning techniques in association with analysis of historical claim data comprising adjudication information for previously adjudicated claims including same or similar attributes to the current claim.
